(19) United States
(12) Patent Application Publication
(10) Pub. No.: US 2007/0220598 A1
(43) Pub. Date: Sep. 20, 2007

(54) PROACTIVE CREDENTIAL DISTRIBUTION

(75) Inventors: Joseph A. Salowey, Seattle, WA (US); Shengyou Zeng, Concord, MA (US)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: CISCO SYSTEMS, INC., San Jose, CA (US)

(21) Appl. No.: 11/424,763

(22) Filed: Jun. 16, 2006

Related U.S. Application Data
(60) Provisional application No. 60/780,176, filed on Mar. 6, 2006.

(51) Int. Cl. H04L 9/32

(52) U.S. Cl. 726/10

(57) ABSTRACT

The innovation discloses an AAA-based key/credential distribution system and methodology that is enhanced for establishing a trust relationship between an end device and network application servers which are known at the time of end device authentication. This enhancement can reduce the complexity of key distribution while increasing performance and computational efficiency. By using information that is typically accessible to an AAA server with respect to which instance of a service a client should use based upon load, location, etc., the subject innovation can proactively distribute credentials to an end device. This proactive distribution enables the end device to directly prompt authentication with a network entity.

### CROSS-REFERENCE TO RELATED APPLICATIONS

This application claims the benefit of U.S. Provisional Patent Application Ser. No. 60/780,176 entitled “Verizon Wireless Multi-Media Plus (MMD+) Program System Architecture Document” filed on Mar. 6, 2006. This application is related to pending U.S. patent application Ser. No. 10/185,503 entitled “Method and Apparatus for Re-Authenticating Computing Devices” filed on Jun. 27, 2002. The entireties of the above-noted applications are incorporated by reference herein.

### BACKGROUND

The foundation of network security is the authentication of network entities. The effectiveness of other network security mechanics such as authorization, integrity check and confidentiality rely upon network entity authentication. Initial authentication is typically performed for network admission control by a provider edge (PE) device when a consumer device (e.g., client, supplicant or end device) such as a cable modem or mobile cellular handset connects to a service provider's network.

An authentication, authorization and accounting server (AAA service) is often employed as a part of the network security architecture with respect to applications such as network access or IP mobility. One application of AAA systems is key distribution to network services. However, existing AAA systems do not support key/credential distribution between an end device and a network application server for use subsequent to initial device authentication.

‘Authentication’ refers to the validation of the claimed identity of an entity, such as a device, which is attaching to a network, or a user, who is requesting network services is a valid user of the network services requested. Authentication is accomplished via the presentation of an identity and credentials (e.g., digital certificates or shared secrets).

‘Authorization’ refers to the granting of access of specific types of services to a user. This grant of access can be based upon a number of factors, including user authentication, services requested, current system state, etc. As well, ‘authorization’ can be restricted in a variety of manners, for example, scope of use, temporal restrictions, physical location restrictions, etc. Finally, ‘accounting’ refers to a mechanism for tracking the consumption and use of network resources and services. This accounting information is often used for billing, load management, research, planning, etc.

‘Authentication’ of an end device is most often performed in a process during network admission. In operation, once an end device (e.g., client, supplicant) has properly established its identity in an initial authentication process, a trust relationship is established between the end device and the PE. To access services offered by the service provider, the end device must also establish a trust relationship with other entities in the service provider's network. Establishing a trust relationship between the end device and other entities is often a difficult problem. The trust relationships are based upon long term credentials and associated information between the end device and a home AAA server. Conventional systems require multiple message exchanges each time authentication to a network application server (e.g., service) is requested.

Some traditional systems employ the Kerberos security authentication system. Although Kerberos is one of the most common methods for distributing short term credentials to network entities, it is known to be difficult to operate and to incur significant performance cost. For example, in operation, Kerberos requires that a client must know the specific instance of a service it must communicate with before it can request credentials. Kerberos also requires one or more separate message exchanges in order to obtain credentials for each network service instance. These separate message exchanges are required even when the network server is known at the time of end device authentication. The bidirectional message exchanges contribute significantly to the reduced performance of an authentication system. In addition, authentication mechanisms used with AAA servers in many networks, such as SIM and AKA, are not available within Kerberos. Finally, having a separate Kerberos KDC as a network service represents yet another device that must be managed.

Although recent developments have been directed to employing AAA servers in connection with the distribution of tickets to a client and proactive distribution of ‘re-authentication’ credentials, there exists a need for a system that can proactively distribute credentials in an effort to enhance establishment of a trust relationship between an end device and network entities within a service provider's network following the initial device authentication with the service provider's network.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

Generally, this innovation describes a method for establishing a trust relationship between an end device and other network entities in a service provider's network based upon the initial authentication of the end device to the service provider's network. More particularly, the innovation disclosed and claimed herein, in one aspect thereof, comprises an AAA-based key/credential distribution system and methodology that is enhanced for establishing a trust relationship between an end device and network application servers which are known at the time of end device authentication. This enhancement can reduce the complexity of key distribution while increasing performance and computational efficiency.

In a system like Kerberos, clients must request credentials from a central third party for a specific instance of a service. If the instance of the service is not known at authentication time, the client would not know what credentials to request. Therefore, in these situations, Kerberos could not be used. By using information that is typically accessible to an AAA server with respect to which instance of a service a client should use based upon configuration, load, location, etc., the subject innovation can proactively distribute credentials without the need for the client to request a specific credential. In this way information can be provided to the client that can enable the client to learn which service instance to contact.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a credential distribution system in accordance with an aspect of the innovation.

FIG. 2 illustrates an exemplary flow chart of procedures that facilitate proactive credential distribution in accordance with an aspect of the innovation.

FIG. 3 illustrates a block architectural diagram of an exemplary authentication, authorization and accounting (AAA) server in accordance with an aspect of the innovation.

FIG. 4 illustrates an exemplary flow chart of procedures that facilitate establishing a shared secret between two devices in accordance with an aspect of the innovation.

FIG. 5 illustrates an exemplary flow chart of procedures that facilitate deriving a credential distribution key and securely distributing the credential(s) to facilitate authorization of a device in accordance with an aspect of the innovation.

FIG. 6 illustrates an exemplary flow chart of procedures that facilitate encrypting the credential into two separate data units in accordance with an aspect of the innovation.

FIG. 7 illustrates an exemplary flow chart of procedures that facilitate authentication by decrypting the credential in accordance with an aspect of the innovation.

FIG. 8 illustrates a block diagram of a computer operable to execute the disclosed architecture.

FIG. 9 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component,” “system” and “server” are intended to refer to a computer-related entity, either hardware, a combination of hardware and software, software, or software in execution. For example, a component can be, but is not limited to being, a process running on a processor, a processor, an object, an executable, a thread of execution, a program, a data structure and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based upon a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

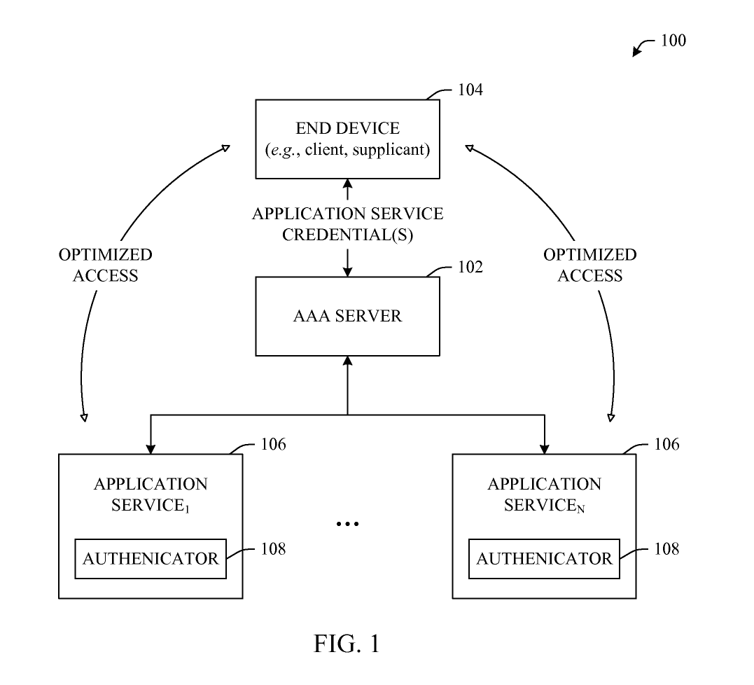

Referring initially to the drawings, FIG. 1 illustrates a system 100 that facilitates proactive credential distribution which can enhance authentication and access to network entities and services related thereto. Generally, system 100 can include an authentication, authorization and accounting server (AAA server 102) that manages access between an end device 104 (e.g., client, supplicant) and 1 to N application services, where N is an integer. It is to be understood that 1 to N application services can be referred to individually or collectively as application service 106. An application service may be embodied in multiple instances. Two features of the subject innovation are the proactive distribution of the credentials for subsequent client-server authentications and the manner in which end devices and applications can then make use of the credentials.

This innovation builds upon information that is most often available to AAA servers. For example, an AAA server (e.g., 102) is aware of the services (e.g., 106) in its network, which client (e.g., 102) is entitled to which services, and which credentials are used within the network to access the services. It will be understood and appreciated that these are core functions of the AAA server 102. Moreover, the AAA server 102 is typically also knowledgeable about the subject's role and/or subscription. From this information, as described below, the AAA server 102 can determine which credentials would be useful to proactively distribute. Trust relationships can be easier to maintain in a home network than in other places. In many scenarios, services (e.g., 106) share some sort of relationship with the AAA server 102.

As illustrated in FIG. 1, supplicant or end device 104 is a client that attempts to gain access to network services 106. As described herein, the terms “supplicant,” “end device” and “client” are intended to be used interchangeably to describe any mobile or portable processing device that participates in the authentication and authorization processes as described herein. For example, a mobile device is intended to include a mobile phone, smartphone, personal data assistant (PDA), pocket computer, laptop computer, notebook computer or any other device that is communicatively coupled to a network using a link. It is further to be understood and appreciated that, although aspects described herein are directed to wireless protocol environments, the novel aspects of the innovation can be applied to wired environments without departing from the scope of this disclosure and claims appended hereto. This includes, but is not limited to a desktop computer, cable modem, DSL modem, home gateway or any other device that is communicatively coupled to a network using a link.

Additionally, as shown, system 100 can include multiple application services 106, each having an authenticator 108 which is a device that provides authentication services and an AAA server 102. It will be understood that the AAA server 102 is a device that actually performs the network authentication of the supplicant 104 to the AAA server 102 and ultimately authorizes access to the application service 106.

The initial part of the conversation between the supplicant 104 and the authenticator 108 is transmitted over some protocol such as Ethernet, IEEE 802.11, HRPD, etc. In one aspect, this carries an Extensible Authentication Protocol (EAP) frame between the supplicant 104 and the authenticator 108. As shown, frequently, the authentication server (e.g., AAA server 102) is located away from the authenticator (e.g., authenticator 108). Thus, traditionally, the authenticator 108 will repackage the EAP frame into an AAA protocol and send them to an AAA server 102 which optionally houses an authentication server 110. Examples of AAA protocols are remote authentication dial-in user service (RADIUS) and DIAMETER.

In many complex networks, especially public access networks, the AAA server 102 is implemented in a distributed server manner. In these scenarios, there is usually a home AAA server that houses the subscriber to a service—to which the subscriber has a relationship. It is to be understood that the novel functionality described herein can be deployed in a distributed AAA server scenario.

In some distributed scenarios, there can also be proxy AAA servers that know how to route these EAP and AAA messages to the correct home AAA server, for example, based upon information received. Thus, when the EAP packet transmits over an AAA protocol, it may be routed to a home network provider who will actually perform the authentication. There are many different types of authentication protocols with different types of credentials that can be carried out as part of the authentication. Some examples are public key infrastructure (PKI) using EAP TLS (extensible authentication protocol transport layer security) which allows use of X.509 certificates to authenticate.

There are also mechanisms that allow authentication based on a pre-shared key. Examples are EAP SIM and EAP AKA which are typically used by service providers. This authentication exchange can take several trips and during that exchange, typically, both parties are authenticated and cryptographic key material can be generated. The cryptographic keys are mutually derived in some fashion according to the authentication protocol of both the supplicant 104 and the AAA server 102. A key, the master session key, derived from this exchanged is typically transmitted from the AAA 102 to the authenticator 108.

This keying material, Master Session Key (MSK), can be used by the supplicant 104 and authenticator 108 to establish a secure association and to cryptographically protect traffic between the supplicant 102 and the authenticator 108.

In aspects, additional keying material, Extended Master Key (EMSK), can be derived from the EAP session. From the EMSK, it is possible to derive additional keys, application specific keys, for additional purposes. In other words, keys can be derived for purposes other than for establishing the cryptographic protection on the layer 2 link between the supplicant 102 and the authenticator 108.

For example, application specific key material can be derived to enhance authentication to another authenticator on the same network or perhaps on a different network. As well, these additional keys can be employed to provide for authentication to other services provided by the network (e.g., application services 106). Examples of these application services can be, but are not limited to, voice related services, mobility services (e.g., mobile IP) or other data related services where keying material can be used. These application services may be distributed amongst any number of application service instances.

One of the difficulties of using this additional keying material is key distribution. The supplicant 102 and the authentication server 108 are the two parties that share the extended keying material (EMSK). In addition to distributing the application specific keys derived from the extended keys to the authenticator 108, the innovation can also facilitate distribution of the additional keys to the end device 104 for subsequent authentication to authenticators 108 in other application services 106. Thus the authenticator 108, or some other appropriate process, can make use of these keys to perform enhanced authentication which can be initiated by the end device 104. In this enhanced authentication it is possible that the authenticator 108 for the application service 106 may not need to contact the AAA server 102.

To accomplish this enhancement, the system 100 facilitates proactive issuance of credentials that can enhance authentication processes between the end device 104 and application service(s) 106. In operation, the application specific key for that service can be encrypted using a secret that is known to the servers (e.g., application service 106) that will make use of the key. As such, the keys can be distributed in a number of different ways to the parties (e.g., end device 104, application service 106) that want to make use of it. In one aspect, the keys and credentials can be distributed back through the same AAA authentication chain as described above. It is to be appreciated that there are many devices that can act as a proxy in the AAA chain. Accordingly, those devices can have keys or these credentials sent specifically to them. Moreover, as will be described in greater detail below, the system 100 can also provide for notifying the client 104 with respect to which key to use for a particular service (e.g., application service 106) and which service instance to contact.

In accordance with conventional AAA systems, synchronization of state occurs using communication in the back end. Primarily, this is because the client does not receive credentials that it can use to distribute state. The subject innovation avoids complicated state transactions on the back end by proactively distributing credentials to the client(s) upon initial authentication.

It will be appreciated that service providers and enterprises can employ the subject innovation to enhance key distribution to end devices to simplify and speed up trust relationship establishment between an end device and network application servers and other network entities when the servers and entities are known at the time of end device authentication. In aspects, this innovation can be used wherever Kerberos or AAA systems are employed.

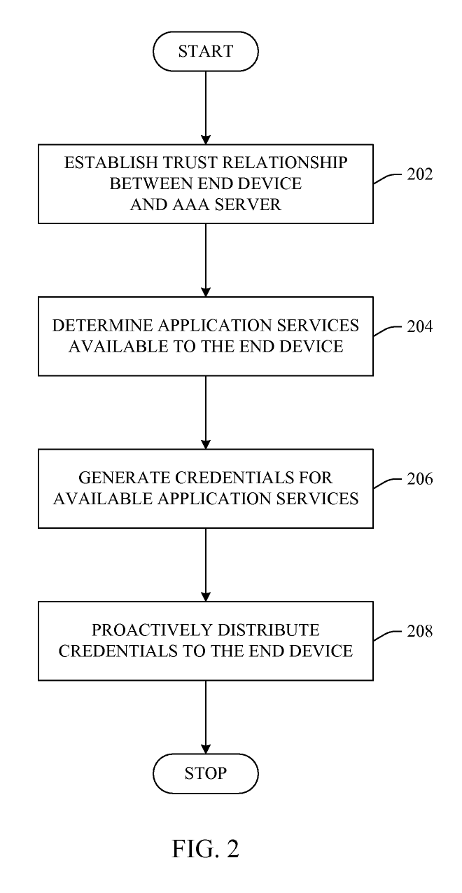

FIG. 2 illustrates a methodology of proactively distributing credentials to a device in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, a trust relationship is established between an end device and an AAA server. As described above, in aspects, EAP and IEEE 802.1x protocols can be employed to effect the authentication. The services available to the end device can be determined at 204. It will be understood and appreciated that one feature of an AAA server is tracking and mapping devices to services. As such, the AAA server will provide the relationship information at 204.

At 206, credentials can be generated with respect to the identified application and/or network services. As will be described in greater detail below, in an aspect, these credentials can be established in at least two separate cryptographically protected data units. The first data unit can identify an appropriate service instance or group of service instances and identities associated to the credential. This information can be used to determine to which service instance the end device should contact to establish service. The second data unit can contain authentication information to be used by the service to effectuate the authentication of the device to the service.

Once the credentials are generated, at 208, the credentials can be proactively distributed to the end device. In operation, the end device can later use these credentials to obtain access to application and/or network services.

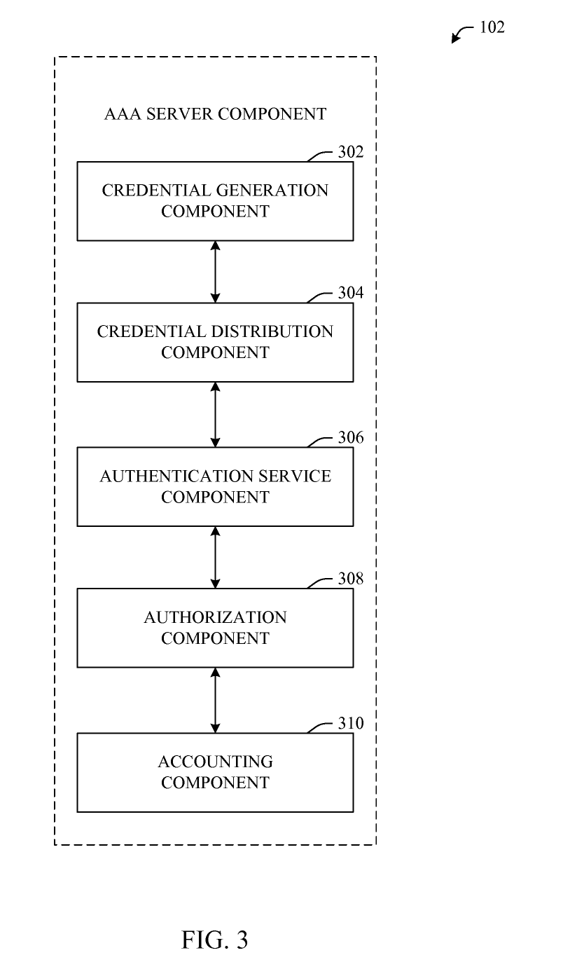

FIG. 3 illustrates a block diagram of an AAA server 102 in accordance with an aspect of the innovation. Generally, the AAA server 102 can include a credential generation component 302 and a credential distribution component 304. It is to be understood that an authentication service component 306 can be located within (as shown), or remotely from, the AAA server 102. By way of example, it will be understood that in alternate aspects, this authentication service component 306 can be remotely located from the AAA server 102 and co-located with the authenticator 108 of FIG. 1. Moreover, as shown and described supra, the AAA server 102 can include authorization and accounting components, 308 and 310 respectively.

As described supra, AAA systems are often used to authenticate an end device to authorize its access to a network. The authentication is based on a trust relationship that is assumed to exist between the AAA system and the end device. Most often, subsequent to the initial authentication, the end device will be challenged for authentication to authorize access to additional services (e.g., application services 106 of FIG. 1) such as mobility services. Conventionally, this subsequent challenge and response exchange requires additional interaction with the AAA server thereby delaying access to the desired service. Additionally, oftentimes, the AAA server will also return information to the end device that indicates which application server to contact for such services. Again, this exchange impacted the performance of traditional systems.

The credential generation component 302 can be employed to generate the credentials described herein. In one particular aspect, the credential generation component 302 can be employed to establish a two-part credential. The credential distribution component 304 can be used to proactively distribute credentials for the services to which an end device needs or desires to communicate. In operation, these credentials can be distributed in connection with the initial authentication.

Essentially, two key aspects of the innovation are the combination of credential distribution together with an indication of what entity to contact for service. As described herein, this indication can be provided within a first data packet of the two packet credential. This proactive credential distribution provides an enhancement upon initial authentication in view of traditional systems.

The distributed credentials can be used to further enhance future authentication to other network entities (e.g., application services and network service entities) in the service provider network. As described above, it is assumed that the AAA system or server 102 can determine which network entities host the service instances the end device will need to access for services. It is also assumed that the AAA system 102 has or establishes a security relationship with each of the network service entities (e.g., application services 106 of FIG. 1) that the end device will access for services.

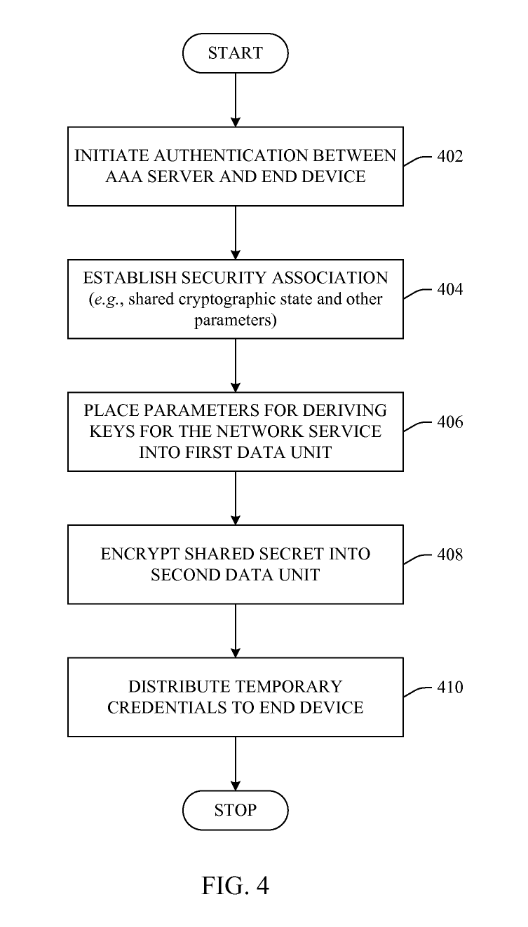

FIG. 4 illustrates a methodology of establishing service credentials in accordance with an aspect of the innovation. At 402, authentication between an AAA server and end device can be initiated. Upon successful initial authentication, at 404, the AAA system establishes shared extended key material with the end device. This extended key material is used to derive an application specific key which is encapsulated in a credential that is to be consumed by application service instances. This temporary credential may be distributed to the application server directly or by way of the end device. The end device can then use the application specific key to authenticate itself to network service entities that possess and can decode the credential.

The temporary credential contains an application specific key derived by the AAA server and the end device from the extended master secret that was obtained during the initial authentication exchange for. Ultimately the application specific key is to be shared between the end device and a network entity that the end device must authenticate to before accessing the services provided by the network entity. At 406 and 408, the AAA system creates two separate data units. The first data unit contains information about the application service instances required by the end device to derive the application specific keys needed to authenticate to the services. This information may include, but is not limited to, identity and address information. This information must be integrity protected and optionally encrypted in a way that allows the end-device to decode the information and have assurance that it has not been changed.

The second data unit is encrypted using a key known only to the network service entity and the AAA server. The second data unit can only be decrypted by the network service entity and cannot be decrypted or modified by the end device. It is to be understood that the data units may contain additional information such as usage constraints (time and space), authorization and identity information. The temporary credential identifies the service and network entity that the end device needs (or may desire) to contact to access the service.

Finally, at 410, both data units are transmitted as a temporary credential and delivered to the end device. This novel technique of pre-distributing credentials to the end device for authentication and service access is referred to as proactive credential distribution. Although aspects of the innovation employ AAA systems for proactive credential distribution, it is to be understood that other authentication mechanisms can be used to effect the proactive credential distribution without departing from the spirit and scope of the innovation and claims appended hereto. In another embodiment of the invention the second data unit may be directly distributed to the network entity where it may be cached.

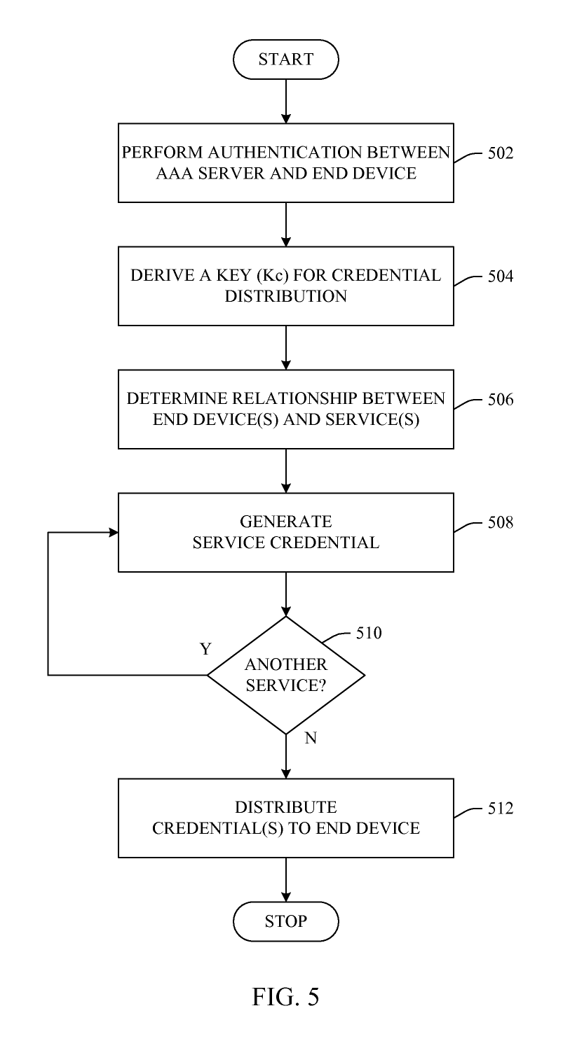

FIG. 5 illustrates an alternative methodology of distributing credentials in accordance with an aspect of the innovation. In general, the steps of proactive credential distribution in accordance with an aspect of the innovation are as illustrated in FIG. 5. At 502, initial authentication between end device and an AAA server is initiated and performed. Following the initial authentication, it is to be understood that the end device and AAA share keys. At 504, the end device and AAA derive a key Kc from the extended session key that can be used for credential distribution.

A determination of relationship(s) between the end device(s) and service(s) can be determined. In other words, the AAA server can determine which services the end device needs or desires to use. As well, the AAA server can determine which network entities the end device will need to contact to obtain access to each service.

At 508, a credential for a service can be generated. As described supra and in greater detail infra, the credential can be a two part credential. A determination is made at 510 if additional services are available to and/or associated with the end device. If at 510 a determination is made that additional services exist, the methodology returns to 508 where appropriate credentials can be generated. If at 510 additional services do not exist, the credentials can be distributed to the end device at 512.

Although the aspects described herein suggest a batch-type distribution, it is to be understood that the credentials can be dynamically distributed as generated. For example, aspects can enhance by prioritizing credentials based upon use, service type, user history, and/or need. Moreover, artificial intelligence and machine learning and reasoning mechanisms can be employed to enhance (by inference) proactive credential generation and/or distribution.

The following scenarios are provided to add perspective to the innovation. It is to be understood and appreciated that the other scenarios exist in addition to the scenarios below. These additional scenarios are to be included within the scope of the disclosure and claims appended hereto.

In a first scenario, the proactive credential distribution can be employed in a mobile to home agent authentication with respect to mobile IP. In accordance with conventional systems, an initial access authentication is performed using an AAA server. Subsequently, the AAA system is queried for the location of the home agent. Next, the end device provides credentials to the home agent which contacts the AAA server again to validate the credentials.

It is to be assumed that this scenario refers to a mobile terminal that is accessing a visited network and will need to communicate with a home agent in its home domain. The home agent can be allocated dynamically thus the mobile terminal does not necessarily know which home agent it will use before it attaches to the network. The home agent in the home domain and the home AAA server are assumed to have a security relationship that can establish medium to long term shared symmetric keys.

This scheme can be extended to support entities in a foreign network as well. Upon attaching to the network, the mobile terminal can be authenticated to gain access to air-link and basic IP services. This process involves a credential exchange with the AAA server which authenticates the user and derives a set of mutually shared keys on the mobile terminal and the AAA server. In one example, the authentication can be carried out in an EAP framework.

Upon successful authentication, the mobile terminal and the AAA server derive keys specifically for encrypting the first data unit of the credential described supra. The AAA server determines which home agent the mobile terminal (e.g., client) will be assigned to and generates the first and second data units of the credential as described above.

In operation, the AAA server generates a session key. The AAA server constructs the first data unit for the mobile by encrypting the session key and additional information using the keys derived from the authentication exchange. The AAA server constructs the second data unit for the home agent by encrypting the session key and additional information using a key known only to the AAA server and the home agent.

Both of these credentials can be proactively transmitted to the mobile terminal as a credential that can be employed to access a particular service. Associated with the credential is the name/address of the home agent the mobile service is assigned to contact. More particularly, the first data unit can include the name/address information which can be decrypted by the mobile unit.

In accordance with this scenario, the credential can be transmitted within the EAP authentication method or external to it. At the time of mobile IP (MIP) registration, the mobile terminal can extract the shared secret contained in the first data unit of the temporary credential. This shared secret can be employed in the calculation of mobile-home authentication extension (MHAE) for the registration request (RRQ). The mobile terminal also includes the second data unit from temporary credential in the RRQ; the temporary credential is included in MHAE calculation. When the home agent (HA) receives the RRQ, it uses its shared key with the AAA system to extract the shared secret from the temporary credential that the mobile presents in the RRQ. Subsequently, the HA uses the extracted shared secret to calculate its version of the MHAE. If the MHAE that the HA calculates matches the MHAE that the mobile presents in the authentication authorization request, then the RRQ and thus the mobile terminal is authenticated. Thereafter, the mobile terminal is granted authorization to access mobile services.

A second scenario is directed to proactive credential distribution in a cable modem to dynamic host configuration protocol (DHCP) server authentication scenario. In an evolving version of the DOCSIS (data-over-cable service interface specification), the cable modem (CM) authenticates to the cable modem terminal system (CMTS), using Baseline Privacy Plus Interface (BPI+), once the CM establishes Layer 2 connection to the CMTS.

In accordance with an aspect of the subject innovation, this authentication can be revised to use an AAA system as part of the EAP authentication framework. In this scenario, the CM can authenticate to an AAA system rather than the CMTS. A trust relationship can be established between the AAA system and the DHCP server that assigns IP addresses to CMs. Upon the successful authentication, the AAA system can distribute a two part temporary credential to the CM.

The shared secret can be encrypted using keys derived from the initial EAP exchange. The shared secret can also be encrypted using the security association between the AAA system and the DHCP server and embedded into the DHCP server portion of the temporary credential. In operation, the CM and the DHCP server use the temporary credential to authenticate DHCP exchanges that follow CM authentication.

In doing so, the CM extracts the shared secret from the temporary credential and uses it in calculating digest of DHCP messages. Likewise, the DHCP server extracts the shared secret from its portion in the temporary credential and uses it in authenticating DHCP messages.

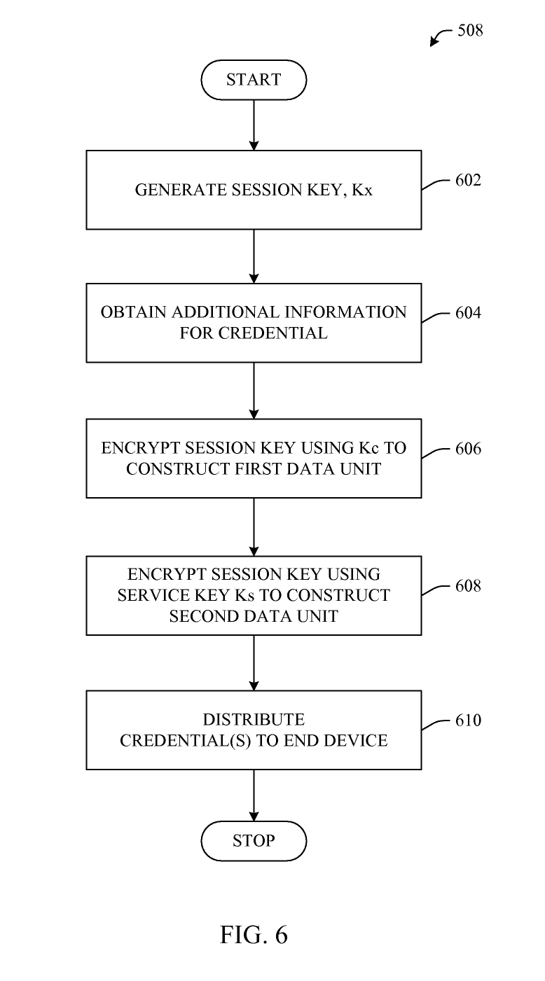

Turning now to FIG. 6, a methodology of generating a two part credential in accordance with an aspect of the innovation is shown. Effectively, the methodology of FIG. 6 is illustrative of acts employed to generate a credential in act 508 of FIG. 5. As shown in FIG. 5, this methodology is recursive for each service associated to an end device.

Beginning at 602, for each service associated to the end device, the AAA server, generates a session key, Kx. Next, at 604, additional data is obtained to be incorporated in the credential such as lifetime, constraints, authorizations, identities, target service, target name/address, etc. One use of this additional information is to inform the end device as to which service applies to which credential.

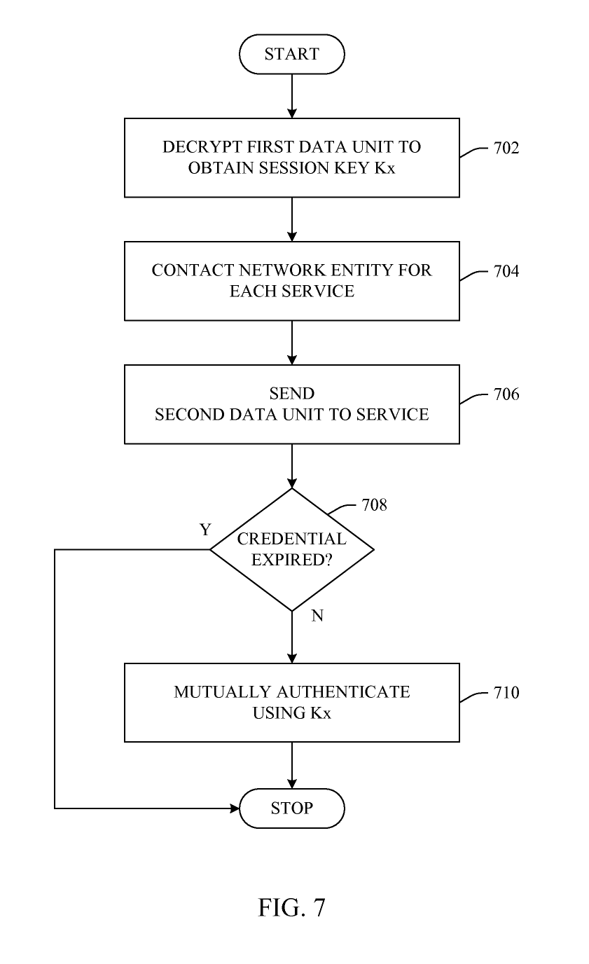

At 606, the session key and additional data are encrypted and integrity protected using a credential distribution key (e.g., Kc derived in act 504 of FIG. 5). This act constructs the first data unit of the temporary credential for the end device. As described above, this first data unit can be later decrypted to identify a service (or group of services) associated with the credential. The decryption and deployment of the credentials will be better understood upon a review of FIG. 7 that follows.

At 608, the second data unit of the credential can be constructed. In accordance with this act, the session key and data can be encrypted and integrity protected using a service key, Ks, which is shared between the AAA server and the network entity providing the service. The encrypted packet constructs the second data unit of the temporary credential for the network entity.

Although the aspects described herein refer to a first and second data unit, it is to be understood that other aspects exist where the contents of each data unit are switched (e.g., the described first unit is the second unit and vice versa). As well, it will be understood that other aspects exist that employ a single data unit as well as more than two data units. These additional aspects are to be considered within the scope of this disclosure and claims appended hereto.

Continuing with the example, once both data units are constructed, at 610, the AAA server can send each credential to the end device. As described above, the credentials can be sent dynamically and/or batched in accordance with disparate aspects. Alternatively the credential that is to be consumed by the application service may be sent directly to the application service if the application service is reachable and has the ability to cache the credential.

Referring now to FIG. 7, a methodology of employing the credential to obtain access to network services is shown. At 702, the end device can decrypt the first data unit portion of each credential to obtain the session key Kx as well as the additional encrypted data, e.g., the type of service, name/address of the network entity providing the service, etc. It will be understood that this additional encrypted data can identify a network entity associated with a needed and/or desired service.

At 704, the target or end device can contact the network entity for each service when necessary. Next, at 706, the second data unit of each credential can be sent to the respective service as identified by the decryption of the first data unit. A determination can be made at 708 if the credential is expired or valid. If expired or invalid, a stop block is reached and a procedure of renewing or granting a valid credential can be commenced.

If the credential is valid and not expired, the network service and end device then perform an authentication protocol in which they can mutually authenticate to one another by proving possession of the session key, Kx. Once mutual authentication is effected, access to the desired service provided by the network entity can be granted.

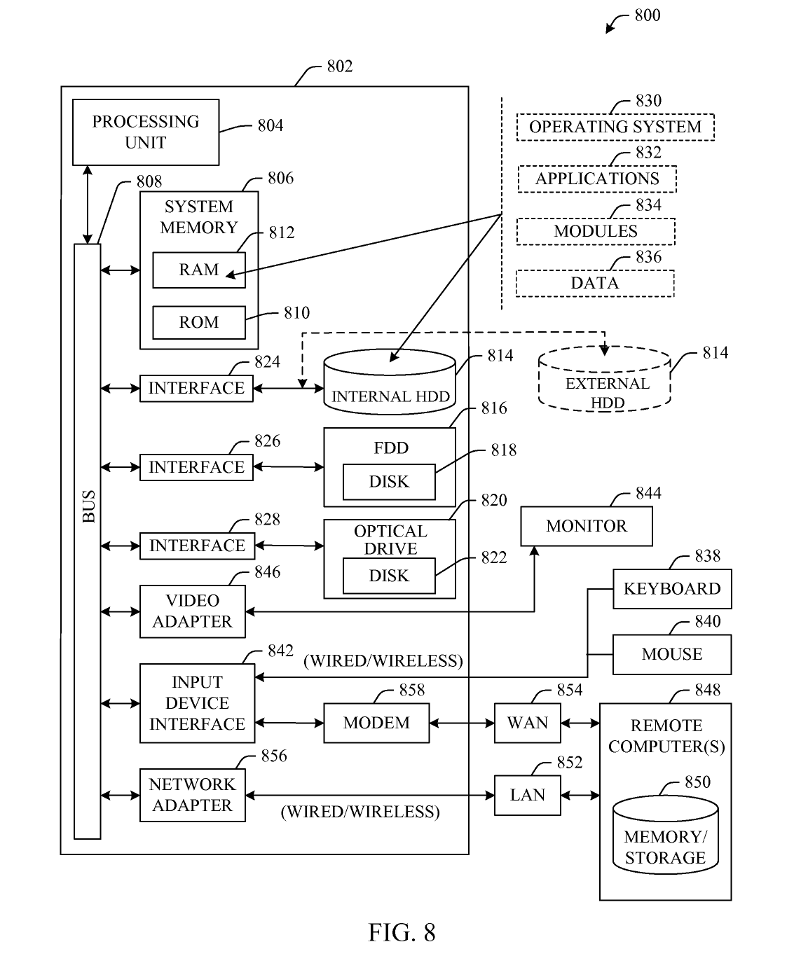

Referring now to FIG. 8, there is illustrated a block diagram of a computer operable to execute the disclosed architecture of proactively distributing credentials in accordance with an aspect of the innovation. In order to provide additional context for various aspects of the subject innovation, FIG. 8 and the following discussion are intended to provide a brief, general description of a suitable computing environment 800 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 8, the exemplary environment 800 for implementing various aspects of the innovation includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA), which internal hard disk drive 814 may also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high capacity optical media such as the DVD). The hard disk drive 814, magnetic disk drive 816 and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 812, including an operating system 830, one or more application programs 832, other program modules 834 and program data 836. All or portions of the operating system, applications, modules, and/or data can also be cached in the RAM 812. It is appreciated that the innovation can be implemented with various commercially available operating systems or combinations of operating systems.

A user can enter commands and information into the computer 802 through one or more wired/wireless input devices, e.g., a keyboard 838 and a pointing device, such as a mouse 840. Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces, such as a parallel port, an IEEE 1394 serial port, a game port, a USB port, an IR interface, etc.

A monitor 844 or other type of display device is also connected to the system bus 808 via an interface, such as a video adapter 846. In addition to the monitor 844, a computer typically includes other peripheral output devices (not shown), such as speakers, printers, etc.

The computer 802 may operate in a networked environment using logical connections via wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which may connect to a global communications network, e.g., the Internet.

When used in a LAN networking environment, the computer 802 is connected to the local network 852 through a wired and/or wireless communication network interface or adapter 856. The adapter 856 may facilitate wired or wireless communication to the LAN 852, which may also include a wireless access point disposed thereon for communicating with the wireless adapter 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 via the serial port interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

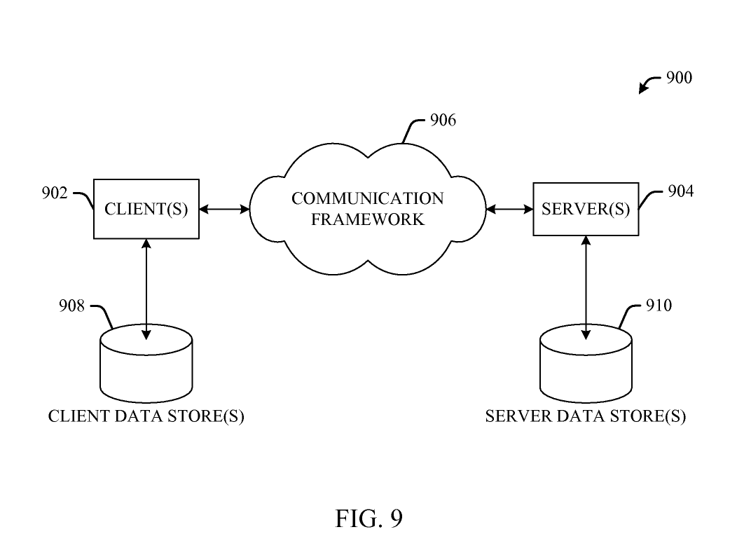

Referring now to FIG. 9, there is illustrated a schematic block diagram of an exemplary computing environment 900 in accordance with the subject innovation. The system 900 includes one or more client(s) 902. The client(s) 902 can be hardware and/or software (e.g., threads, processes, computing devices). The client(s) 902 can house cookie(s) and/or associated contextual information by employing the innovation, for example.

The system 900 also includes one or more server(s) 904. The server(s) 904 can also be hardware and/or software (e.g., threads, processes, computing devices). The servers 904 can house threads to perform transformations by employing the innovation, for example. One possible communication between a client 902 and a server 904 can be in the form of a data packet adapted to be transmitted between two or more computer processes. The data packet may include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented method of authenticating a device to a plurality of network services, comprising:
establishing a trust relationship between the device and an authentication server;
determining the plurality of network services available to the device;
generating a plurality of credentials that facilitate authorization of the device to a subset of the plurality of network services; and
proactively distributing a subset of the plurality of credentials to the device.

2. The computer-implemented method of claim 1, each of the plurality of credentials is a two-part credential.

3. The computer-implemented method of claim 1, further comprising:
establishing a shared secret between the device and at least one of the network services; and
encoding information that allows an authorized party to recover the shared secret into a first data unit of the credential.

4. The computer-implemented method of claim 3, the act of encoding includes an act of encrypting the shared secret.

5. The computer-implemented method of claim 3, the act of encoding includes an act of providing information that derives the shared secret from a previously established cryptographic key.

6. The computer-implemented method of claim 3, further comprising encoding the shared secret into a second data unit of the credential.

7. The computer-implemented method of claim 6, further comprising establishing a cryptographic distribution key between the device and the authentication server.

8. The computer-implemented method of claim 7, the act of encoding information into the first data unit employs the cryptographic distribution key to protect the shared secret.

9. The computer-implemented method of claim 8, the act of establishing a shared secret comprises generating a cryptographic session key between the device and each of the plurality of network services, the cryptographic session key is the shared secret.

10. The computer-implemented method of claim 9, the act of encrypting the shared secret into the second data packet employs a cryptographic service key which is a key derived between the authentication server and each of the plurality of network services.

11. The computer-implemented method of claim 1, further comprising decrypting a first data unit of one of the plurality of credentials to identify a session key.

12. The computer-implemented method of claim 11, further comprising identifying at least one of the subset of the plurality of network services associated with the device as a function of the decrypted first data unit.

13. The computer-implemented method of claim 12, further comprising transmitting a second data unit that corresponds to the first data unit to the at least one of the plurality of network services.

14. The computer-implemented method of claim 13, further comprising:
decrypting the second data unit;
authenticating the device; and
authorizing access to the at least one of the plurality of network services.

15. A system that facilitates authorizing service access to an end device, comprising:
a first device that desires access to a network service; and
a second device that authenticates the first device and distributes a portion of the credential to the first device that facilitates access to the network service.

16. The system of claim 15, the second device distributes a portion of the credential to the network service.

17. The system of claim 15, the second device is an authentication authorization and accounting (AAA) server.

18. The system of claim 16, the AAA server comprises:
a credential generation component that establishes the credential; and
a credential distribution component that proactively distributes the credential to the first device.

19. The system of claim 16, the credential is a two-part credential having a first portion that identifies the network service and a second portion that enables the network service to grant access to the first device.

20. A computer-executable system that facilitates authentication between a device and a network entity, comprising:
means for authenticating the device to an AAA server;
means for establishing a shared secret between the device and the network entity;
means for encrypting the shared secret into a first portion of a credential;
means for encrypting the shared secret into a second portion of the credential; and
means for communicating the credential to the device.

21. The system of claim 20, further comprising:
means for decrypting the first portion of the credential; and
means for transmitting the second portion of the credential to the network entity which is identified within the decrypted first portion of the credential.

22. The system of claim 21, further comprising:
means for decrypting the second portion of the credential; and
means for granting access to a network service based at least in part upon the decrypted second portion of the credential.

23. The system of claim 20, the means for authenticating the device is at least one of EAP-SIM, EAP-TLS, LEAP, EAP-AKA, EAP-FAST and PEAP.
